(19) United States
(12) Patent Application Publication
(10) Pub. No.: US 2026/0267786 A1
(43) Pub. Date: Sep. 10, 2026

(54) DATA PROCESSING SYSTEMS

(71) Applicant: Arm Limited, Cambridge (GB)

(72) Inventors: Philip John YOUNG, Grange Park (GB); Damian Piotr MODRZYK, Katowice (PL); Robert SARKOEZI, Biatorbagy (HU)

(73) Assignee: Arm Limited, Cambridge (GB)

(21) Appl. No.: 19/072,308

(22) Filed: Mar. 6, 2025

(51) Int. Cl. G06F 12/02

(52) U.S. Cl. CPC G06F 12/0223

(57) ABSTRACT

A data processing system is disclosed that includes one or more data processing units and a data reordering unit. The data reordering unit receives data requested by the one or more data processing units from the memory system, and returns the data to the one or more data processing units in an order that is based on tracking an order of requests issued by the one or more data processing units.

### BACKGROUND

The technology described herein relates to data processing systems, and in particular to data reordering in data processing systems, such as graphics processing systems.

When a data processing unit, such as a display processor (DPU), of a data processing system requires data that is stored in a memory system, the data processing unit may issue one or more requests for the data to the memory system, and the memory system may respond to the request(s) by returning the requested data to the data processing unit. The time taken for a memory system to respond and return any given data may vary, such that the memory system may return data in a fragmented or interleaved form and “out-of-order”, i.e. in a different order to an order in which the data processing unit requested the data. To account for this, the data processing unit may reorder data returned by the memory system for processing.

The Applicants believe that there remains scope for improvements to data reordering arrangements in data processing systems.

### BRIEF DESCRIPTION OF THE DRAWINGS

Embodiments of the technology described herein will now be described by way of example only and with reference to the accompanying drawings, in which:

FIG. 1 shows an exemplary data processing system;

FIG. 2 shows operation of a display controller;

FIG. 3 shows an exemplary data processing system;

FIG. 4 shows a data processing system in accordance with embodiments;

FIG. 5 shows a shared data reordering buffer unit (RBU) in accordance with embodiments;

FIG. 6 shows operation of a shared data reordering buffer unit (RBU) in accordance with embodiments;

FIG. 7 shows operation of a shared data reordering buffer unit (RBU) in accordance with other embodiments; and

FIG. 8 shows a combined data reordering and compression codec unit in accordance with embodiments.

Like reference numerals are used for like components where appropriate in the drawings.

### DETAILED DESCRIPTION

A first embodiment of the technology described herein comprises a data processing system comprising:
one or more data processing units configured to issue requests for data stored in a memory system; and
a data reordering unit configured to:
   track an order of requests for data issued by the one or more data processing units;
   receive data requested by the one or more data processing units from the memory system; and
   return data received from the memory system to the one or more data processing units in an order based on the tracking.

A second embodiment of the technology described herein comprises a method of operating data processing system that comprises:
one or more data processing units configured to issue requests for data stored in a memory system; and
a data reordering unit;
the method comprising the data reordering unit:
   tracking an order of requests for data issued by the one or more data processing units;
   receiving data requested by the one or more data processing units from the memory system; and
   returning data received from the memory system to the one or more data processing units in an order based on the tracking.

The technology described herein relates to a data processing system, such as a graphics processing system, that includes one or more data processing units, such as one or more of: a central processing unit (CPU), a graphics processing unit (GPU), a video processing unit (VPU), a display processing unit (DPU), etc. The system should, and in embodiments does, include a memory system that the one or more data processing units can (each) access (read from and/or write to), e.g. by issuing appropriate requests to access the memory system, e.g. in the normal manner for the data processing system in question.

The system further includes a data reordering unit that should be, and in embodiments is, (configured to be) in communication with (each of) the one or more data processing units and the memory system. The data reordering unit is configured to receive data requested by the one or more data processing units from the memory system, and return the data to the one or more data processing units in an order that is based on tracking an order of requests issued by the one or more data processing units. The data reordering unit can thus, and in embodiments does, reorder data returned by the memory system and return the reordered data to a data processing unit, e.g. in an order that the data processing unit originally requested the data.

As will be discussed in more detail below, the inventors have recognised that it can be advantageous to provide a data reordering unit in a data processing system that performs data reordering operations for other data processing units of the data processing system. For example, multiple different data processing units can, and in embodiments do, share the same data reordering unit, and this can reduce or remove the requirement for each data processing unit to be provided with a respective private data reordering buffer. This can reduce overall hardware/silicon area costs and energy consumption associated with data reordering operations.

It will be appreciated, therefore, that the technology described herein provides an improved data processing system.

The data processing system should, and in embodiments does, comprise a (the) memory system that (each of) the one or more data processing units (and the data reordering unit) can access, e.g. read from and/or write to. The memory system may comprise any suitable and desired storage for storing any suitable data that the data processing system uses and/or produces, such as image data, texture data, graphics processing fragment or vertex data, video data, sound data, neural network data, etc.

In embodiments, the system comprises (at least) a main (system) memory that is, in embodiments, an external memory, e.g. not on the same chip as the one or more data processing units and/or the data reordering unit. The memory system may (further) comprise a cache system (hierarchy), e.g. via which the one or more data processing units and/or the data reordering unit can communicate with the (main) memory.

In embodiments, the system comprises a communications bus (interconnect) in communication with (each of) the one or more data processing units (and the data reordering unit) and the memory system, and via which the one or more data processing units (and the data reordering unit) can (each) access the memory system. The communications bus can be any suitable and desired interconnect, e.g. over which bus transactions to access the (e.g. main) memory can be performed by (each of) the one or more data processing units (and the data reordering unit).

The one or more data processing units can be any suitable processor(s)/accelerator(s), such as one or more of: a central processing unit (CPU), a graphics processing unit (GPU) (graphics processor), a video processing unit (VPU) (video processor), a neutral network processing unit (NPU) (neural accelerator), a display processing unit (DPU) (display controller), a compression codec unit, a sound processor, an image signal processor (ISP), a digital signal processor (DSP), another type of data processing unit, etc.

The one or more data processing units may comprise a host processor, e.g. a central processing unit (CPU). For example, the data processing system may be a graphics processing system that comprises a graphics processing unit (GPU) (graphics processor), and a host processor, e.g. a central processing unit (CPU), that may execute applications that can require graphics processing by the graphics processor (GPU), and send appropriate commands and data to the graphics processor (GPU) to control it to perform graphics processing operations and to produce graphics processing (render) output (e.g. images (frames) for display) required by applications executing on the host processor (e.g. CPU). To facilitate this, the (host processor) data processing unit (e.g. CPU) may also execute a driver for the graphics processor (GPU). The data (e.g. graphics) processing system may (further) comprise a display processing unit (DPU) (display controller) that provides graphics processing (render) output (e.g. images (frames) for display) for display by a display.

In embodiments, a (each) data processing unit comprises a (respective) bus interface (bus adapter) that is in communication with the communications bus (interconnect), and via which the (respective) data processing unit can initiate bus transactions (requests) on the bus (interconnect), e.g. to access the memory system. Thus, in embodiments, (a bus interface of) a (each) data processing unit is configured to issue requests for data stored in the memory system on the communications bus.

The data reordering unit can be any suitable (e.g. system) component that should be, and in embodiments is, configured to reorder data returned by the memory system for (each of) the one or more data processing units. The data reordering unit should be, and in embodiments is, (logically) between (each of) the one or more data processing units and the (e.g. main) memory, e.g. and in embodiments, such that the data reordering unit can intercept requests and data (bus transaction communications) between the one or more data processing units and the memory.

The data reordering unit may be external to (e.g. not on the same chip as) the one or more data processing units. In embodiments, the data reordering unit is provided on the same chip as the one or more data processing units.

The data reordering unit may be integrated in the communications bus (interconnect). In embodiments, the data reordering unit is a separate unit to (each of) the one or more data processing units, e.g. that is in communication with (each of) the one or more data processing units and the memory system via the (system) communications bus (interconnect). Thus, in embodiments, the data reordering unit comprises one or more bus interfaces (bus adapters) in communication with the communications bus (interconnect), and via which the data reordering unit can receive and initiate bus transactions (requests) on the bus (interconnect), e.g. to receive requests and data, and access the memory system, etc.

The data reordering unit may be in communication with only one data processing unit. However, in embodiments, the data reordering unit is in communication with plural different data processing units, and is configured to reorder data returned by the memory system for (each of) the plural different data processing units. Thus, in embodiments, the one or more data processing units are two or more data processing units, and the data reordering unit is a shared data reordering unit that is configured to be in communication with the two or more data processing units and the memory system.

The data reordering unit may reorder data returned by the memory system for a data processing unit in any suitable manner. In embodiments, (a bus interface of) the data reordering unit is configured to receive (via the communications bus) (read) requests for data issued by a (each) data processing unit of the one or more (e.g. two or more) data processing units. In embodiments, in response to receiving a (read) request for data issued by a data processing unit, the data reordering unit starts to track the request.

The data reordering unit may track each request for data issued by a data processing unit that the data reordering unit is in communication with. In embodiments, a (each) data processing unit is able to trigger the data reordering unit to track a request (or not), and the data processing unit (only) tracks those requests that a data processing unit triggers the data processing unit to track.

A data processing unit may cause the data reordering unit to track a request for data in any suitable manner. In embodiments, a (each) data processing unit is configured to issue a request for data that indicates whether (or not) the request should be handled by the data reordering unit, and the data reordering unit (only) tracks those requests for data that indicate that the request should be handled by the data reordering unit.

Thus, in embodiments, in response to receiving a request for data issued by a data processing unit, the data reordering unit determines whether the request should be tracked by the data reordering unit, and when it is determined that the request should be tracked by the data reordering unit, tracks the request.

In embodiments, when it is not determined that the request should be tracked by the data reordering unit (when it is determined that the request should not be tracked by the data reordering unit), the data reordering unit does not track the request. The data reordering unit may not respond (at all) to a request that does not indicate that it is to be handled by the data reordering unit, or the data reordering unit may forward such a request (over the communications bus), e.g. such that the forwarded request can reach and trigger another component of the system appropriately.

A request for data issued by a data processing unit may indicate whether (or not) it should be handled by the data reordering unit in any suitable manner. In embodiments, the data processing unit can issue a specific, in embodiments selected, in embodiments predetermined, (e.g. sideband) signal that indicates that an associated request should be handled by the data reordering unit. Alternatively, the data reordering unit may be associated with a set of addresses, and a request for data issued by a data processing unit may indicate that it should be handled by the data reordering unit by indicating an address within the set of addresses associated with the data reordering unit. Other arrangements are possible.

In embodiments, the data reordering unit tracks an order of (read) requests received from a data processing unit (that are to be handled by the data reordering unit). An order of requests can be tracked in any suitable manner. In embodiments, the data reordering unit maintains information indicating an age of a (each) request it is tracking. The data reordering unit may maintain, for example, information indicating a time at which a (each) request was received or issued, e.g. in a table or other data structure.

In embodiments, the data reordering unit tracks an order of requests by queuing received requests in a request queue. Thus, in embodiments, the data reordering unit maintains one or more request queues. In embodiments, in response to receiving a request for data issued by a data processing unit, the data reordering unit queues the request in (at the tail of) a request queue.

The data reordering unit may maintain only one request tracking stream (e.g. request queue) that e.g. tracks an order of all requests that the data reordering unit is tracking. In embodiments, the data reordering unit can maintain plural different request tracking streams (e.g. request queues), e.g. so as to track an order of different types of request separately.

The data reordering unit may, for example, maintain a respective request tracking stream (e.g. request queue) for each data processing unit that the data reordering unit is in communication with (and track (e.g. queue) requests issued by a data processing unit in a respective request tracking stream (e.g. request queue) for that data processing unit).

In embodiments, the data reordering unit comprises a pool of allocatable request tracking streams (e.g. request queues) that the data reordering unit can allocate. The data reordering unit may, for example, allocate a request tracking stream (e.g. request queue) from the pool to a (each) data processing unit that requires data reordering operations.

In embodiments, in response to receiving a (read) request for data issued by a data processing unit, the data reordering unit determines whether a request tracking stream (e.g. request queue) (of the pool) has already been allocated to the data processing unit. In embodiments, when it is determined that a request tracking stream (e.g. request queue) has already been allocated to the data processing unit, the request is tracked by (e.g. queued in) the (already) allocated request tracking stream (e.g. request queue).

In embodiments, when it is not determined that a request tracking stream (e.g. request queue) has already been allocated to the data processing unit (when it is determined that a request tracking stream (e.g. request queue) has not been allocated to the data processing unit), a request tracking stream (e.g. request queue) (of the pool) is allocated to the data processing unit, and the request is tracked by (e.g. queued in) the (newly) allocated request tracking stream (e.g. request queue).

In embodiments, once the data reordering unit has received and started to track (e.g. queue) a (“primary”) request for data issued by a data processing unit, the data reordering unit issues one or more (“secondary”) requests for the data to the memory system to cause the memory system to return the data (originally requested by the data processing unit) to the data reordering unit.

Thus, in embodiments, (a bus interface of) the data reordering unit is configured to issue (on the communications bus) requests for data stored in the memory system. In embodiments, the data reordering unit is configured to, in response to receiving a primary (read) request for data from a data processing unit, (track the primary request and) issue one or more secondary (read) requests for the data to the memory system.

The data reordering unit may, in response to a primary request for data, issue one secondary request to the memory system for the same data. Alternatively, the data reordering unit may, in effect, divide a primary request into plural secondary requests (e.g. for smaller amounts of data), or combine plural primary requests into a single secondary request (e.g. for a combined, larger amount of data), e.g. based on memory system requirements, etc. The data reordering unit may limit a number of pending secondary requests to a maximum number, e.g. based on memory system requirements, etc. Thus, in embodiments, the data reordering unit is configured to schedule (secondary) requests for data stored in the memory system.

In response to a (secondary) request for data issued by the data reordering unit, the memory system should, and in embodiments does, return the requested data to the data reordering unit (via the communications bus). Thus, (a bus interface of) the data reordering unit is configured to receive (via the communications bus) data from the memory system.

In embodiments, the time taken for the memory system to return requested data is variable, such that the memory system may return data “out-of-order”, i.e. in a different order to an order in which the data was requested. To account for this, the data reordering unit should be, and in embodiments is, configured to reorder data returned by the memory system.

To facilitate this, in embodiments, the data reordering unit comprises local storage to store (buffer) data returned by the memory system. Thus, in embodiments, in response to receiving data from the memory system, the data reordering unit stores the data in local storage.

The local storage may comprise a single “chunk” of storage space that is used to store (buffer) any/all data returned by the memory system. In embodiments, the local storage can be effectively divided into separate regions of storage space, e.g. for storing data returned by the memory system for different request tracking streams (e.g. request queues) separately.

In embodiments, the data reordering unit allocates a region of local storage space for use by a request tracking stream (e.g. request queue) when allocating the request tracking stream (e.g. request queue). Thus, in embodiments, allocating a request tracking stream comprises reserving a region of the local storage for storing data returned by the memory system for requests tracked by that request tracking stream.

In embodiments, the data reordering unit (only) issues a (secondary) request for data to the memory system when the there is sufficient space available in the local storage (for the request tracking stream in question) to store the data, e.g. to avoid overflow. When there is not sufficient space available in the local storage, the data reordering unit may stall issuing a (secondary) request for data until there is sufficient space available in the local storage.

In embodiments, the size of a region of local storage space allocated for use by a request tracking stream (e.g. request queue) is selected based on a degree to which latency/stalling may be acceptable for requests tracked by that request tracking stream (e.g. request queue). For example, a larger region of local storage space may be allocated for use by a request tracking stream to decrease the likelihood of latency/stalls for requests tracked by that request tracking stream.

In embodiments, the data reordering unit returns data stored in the local storage to a data processing unit in an order that is based on a tracked order of (read) requests, e.g. based on the age indicating information. Thus, (a bus interface of) the data reordering unit is configured to return (via the communications bus) data received from the memory system to a data processing unit. In embodiments, (a bus interface of) the data reordering unit is configured to generate one or more (read) responses to return data to a data processing unit (via the communications bus).

In embodiments, the data reordering unit stores (buffers) data returned by the memory system in the local storage (at least) until data for any older (read) requests (in the same request tracking stream, e.g. request queue) has been returned to a data processing unit. In embodiments, the data reordering unit determines whether all of the data for an oldest tracked (read) request (of a request tracking stream, e.g. request queue) has been returned by the memory system (and is stored in the local storage), and when it is determined that all of the data for an oldest tracked (read) request (of a request tracking stream, e.g. request queue) has been returned by the memory system (and is stored in the local storage), returns the data to the data processing unit (e.g. by generating one or more (read) responses).

For example, the data reordering unit may determine whether data for a (read) request at the head of a request queue has been received from the memory system, and when it is determined that data for a (read) request at the head of a request queue has been received from the memory system, return the data to a data processing unit (e.g. by generating one or more (read) responses).

The data reordering unit may thus generate (read) responses to (read) requests issued by a data processing unit in the order that the (read) requests were received by the data reordering unit.

In this way, the data reordering unit may return data to a data processing unit in an order that the data processing unit requested the data in (even if the memory system returned the data to the data reordering unit in a different order). The data reordering unit may thus reorder data returned by the memory system, and return the reordered data to the data processing unit.

The data reordering unit may return data to a data processing unit as soon as all of the data for an oldest tracked (read) request has been returned by the memory system (and is stored in the local storage). In embodiments, a (each) data processing unit is able to signal to the data reordering unit when the data processing unit is ready to receive data, and the data reordering unit (only) returns data to a data processing unit when all of the data for an oldest tracked (read) request has been returned by the memory system (and is stored in the local storage) and when the data reordering unit has received a signal from the data processing unit indicating that the data processing unit is ready to receive the data.

To facilitate this, in embodiments, a (each) data processing unit is configured to issue a first type of request (a “pre-fetch request”) that causes the data reordering unit to request data from the memory system, and to store (buffer) data returned by the memory system in the local storage, but to not (yet) return the data to the data processing unit. In embodiments, a (each) data processing unit is (further) configured to issue a second type of request that causes the data reordering unit to return data to the data processing unit. In embodiments, a data processing unit issues a first type of request when it is not yet ready to receive data, and issues a second type of request when it is ready to receive data. Other arrangements are possible.

The data reordering unit may return any/all data to a data processing unit (strictly) in request order. However, in embodiments, a (each) data processing unit is able to trigger the data reordering unit to prioritise a (read) request, e.g. so that data for the request is returned to the data processing unit as soon as the data reordering unit has received the data from the memory system, e.g. thereby (potentially) “skipping the queue”.

To do this, in embodiments, a (each) data processing unit is configured to issue a (read) request for data that indicates whether (or not) the data reordering unit should prioritise the request (return data for the request as soon as possible), and the data reordering unit prioritises a request (returns data for the request as soon as possible) that indicates that the data reordering unit should prioritise the request. Whether or not the data reordering unit should prioritise a request may be indicated e.g. by an appropriate (e.g. sideband) signal or address associated with the request.

Thus, in embodiments, in response to receiving a request for data issued by a data processing unit, the data reordering unit determines whether the request should be prioritised, and when it is determined that the request should be prioritised, prioritises the request (returns data for the request to the data processing unit as soon as possible, and potentially not in request order). In embodiments, when it is not determined that the request should be prioritised (when it is determined that the request should not be prioritised), the data reordering unit does not prioritise the request (and returns data for the request to the data processing unit in request order, e.g. as described above).

The data reordering unit may, for example and in embodiments, queue a non-prioritised request at the tail of a request queue, and queue a prioritised request at the head of a request queue. Other arrangements are possible.

In embodiments, once the data reordering unit has returned data for a request to a data processing unit, the data reordering unit stops tracking the request. For example, the request may be removed from a request queue.

The data requested by a data processing unit and returned by the data reordering unit can be any suitable data that the data processing unit may process. In embodiments, the data is stored in encoded (e.g. compressed) form in the memory system, but is processed by a data processing unit in decoded (e.g. decompressed) form. To allow for this, the data processing system may comprise a compression codec that is configured to encode and/or decode (compress and/or decompress) data, e.g. in accordance with a suitable encoding scheme.

A data processing unit of the one or more data processing units may be a compression codec unit that comprises the compression codec that encodes and/or decodes (compresses and/or decompresses) the data. However, in embodiments, the data reordering unit comprises the compression codec that encodes and/or decodes (compresses and/or decompresses) the data.

Thus, in embodiments, (a bus interface of) the data reordering unit is configured to (in response to a (primary) request for data issued by a data processing unit) issue (on the communications bus) one or more (secondary) requests for encoded (compressed) data stored in the memory system. In embodiments (a bus interface of) the data reordering unit is configured to receive (via the communications bus) data from the memory system in encoded (compressed) form. In embodiments, the data reordering unit is configured to store (buffer) data received from the memory system in the local storage in encoded (compressed) form.

In embodiments, (the compression codec of) the data reordering unit is configured to decode (decompress) data stored in the local storage in encoded (compressed) form. In embodiments, the data reordering unit is configured to return decoded (decompressed) data (decoded (decompressed) by the compression codec) to a data processing unit in an order that is based on a tracked order of requests.

In embodiments, the data reordering unit determines whether all of the encoded (compressed) data for an oldest tracked (read) request (of a request tracking stream, e.g. request queue) has been returned by the memory system (and is stored in the local storage), and when it is determined that all of the encoded (compressed) data for an oldest tracked (read) request (of a request tracking stream, e.g. request queue) has been returned by the memory system (and is stored in the local storage), decodes (decompresses) the encoded (compressed) data and returns the decoded (decompressed) data to a data processing unit.

Data may be encoded (compressed) in accordance with any suitable encoding scheme. An encoding scheme may be any suitable lossless or lossy compression scheme. For example, the encoding scheme may comprise Adaptive Scalable Texture Compression (ASTC), e.g. as described in US 2012/0281007, the entire contents of which is hereby incorporated by reference, or Arm Frame Buffer Compression (AFBC), e.g. as described in US 2013/0036290 and US 2013/0198485, the entire contents of which is hereby incorporated by reference. Other encoding schemes are possible.

In embodiments, the encoding scheme encodes (compresses) data with a fixed compression ratio. For example, the encoding scheme may comprise Arm Fixed Rate Compression (AFRC), e.g. as described in US 2021/0126736 and US 2022/0014767, the entire contents of which is hereby incorporated by reference. Other fixed compression ratio encoding schemes are possible. Thus, in embodiments, the data reordering unit is configured to store (buffer) data in the local storage in encoded (compressed) form with a fixed compression ratio. This can reduce an amount of storage space required for the local storage.

In embodiments, the encoding (compression) scheme is block-based. Thus, in embodiments, an array of data (e.g. image array) is divided into a plurality of compression blocks, and encoded (compressed) data for each compression block (compression unit (CU)) is stored (in the memory system). Encoded (compressed) data for each block may be stored (in the memory) at a respective memory address that can be determined based on the position within the array that the respective block represents (e.g. as described in US 2013/0036290). Other arrangements are possible.

Thus, in embodiments, the data reordering unit issues (secondary) requests for, receives, stores in the local storage, and decodes (decompresses), encoded (compressed) data for one or more compression blocks (compression units (CUs)).

Thus, in embodiments, the data reordering unit is a data reordering and compression codec unit. In embodiments, the data reordering unit is a compression codec unit (that is operable to compress and/or decompress data).

Thus, another embodiment of the technology described herein comprises a data processing system comprising:
one or more data processing units configured to issue requests for data stored in a memory system; and
a data reordering and/or compression codec unit configured to:
   track an order of requests for data issued by the one or more data processing units;
   receive data requested by the one or more data processing units from the memory system in encoded form;
   decode data received from the memory system in encoded form; and
   return decoded data to the one or more data processing units in an order based on the tracking.

Another embodiment of the technology described herein comprises a method of operating data processing system that comprises:
one or more data processing units configured to issue requests for data stored in a memory system; and
a data reordering and/or compression codec unit;
the method comprising the data reordering and/or compression codec unit:
   tracking an order of requests for data issued by the one or more data processing units;
   receiving data requested by the one or more data processing units from the memory system in encoded form;
   decoding data received from the memory system in encoded form; and
   returning decoded data to the one or more data processing units in an order based on the tracking.

These embodiments can, and in embodiments do, include any one or more or all of the optional features described herein, as appropriate.

In embodiments, once a data processing unit receives (reordered) data returned (and optionally decoded (decompressed)) by the data reordering unit, it processes the returned data.

A data processing unit of the one or more data processing units that requests and processes data can be any suitable processor that requests and processes any suitable data, e.g. as discussed above. In particular embodiments, a display processing unit (DPU) (display controller) issues (read) requests for image data in display order (in an order that image data is to be displayed by a display), e.g. at a display frequency (refresh frequency).

Thus, another embodiment of the technology described herein comprises a data processing system comprising:
a display processing unit configured to issue requests for image data stored in a memory system in display order (at display frequency); and
a data reordering unit configured to:
   track an order of requests for image data issued by the display processing unit;
   receive image data requested by the display processing unit from the memory system; and
   return image data received from the memory system to the display processing unit in an order based on the tracking (in display order);
wherein the display processing unit is configured to cause a display to display images (in display order) (at display frequency) using image data returned by the data reordering unit.

Another embodiment of the technology described herein comprises a method of operating data processing system that comprises:
a display processing unit configured to issue requests for image data stored in a memory system in display order (at display frequency); and
a data reordering unit;
the method comprising the data reordering unit:
   tracking an order of requests for image data issued by the display processing unit;
   receiving image data requested by the display processing unit from the memory system; and
   returning image data received from the memory system to the display processing unit in an order based on the tracking (in display order); and
the method further comprising the display processing unit causing a display to display images (in display order) (at display frequency) using image data returned by the data reordering unit.

These embodiments can, and in embodiments do, include any one or more or all of the optional features described herein, as appropriate.

Another embodiment comprises a data reordering and/or compression codec unit comprising:
one or more interfaces for communicating with one or more data processing units and a memory system; and
a processing circuit configured to:
   track an order of requests for data received by the one or more interfaces from the one or more data processing units; and
   cause the one or more interfaces to receive data requested by the one or more data processing units from the memory system, and return the data to the one or more data processing units in an order based on the tracking.

Another embodiment comprises a method of operating a data reordering unit and/or compression codec unit that comprises one or more interfaces for communicating with one or more data processing units and a memory system; the method comprising:
tracking an order of requests for data received by the one or more interfaces from the one or more data processing units; and
causing the one or more interfaces to receive data requested by the one or more data processing units from the memory system, and return the data to the one or more data processing units in an order based on the tracking.

These embodiments can, and in embodiments do, include any one or more or all of the optional features described herein, as appropriate.

The technology described herein can be implemented in any suitable system, such as a suitably operable micro-processor based system. In some embodiments, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, units, and “means” of the technology described herein may comprise a suitable processor or processors, controller or controllers, functional units, circuitry, circuits, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

It should also be noted here that the various functions, etc., of the technology described herein may be duplicated and/or carried out in parallel on a given processor. Equally, the various processing stages may share processing circuits/circuitry, etc., if desired.

Furthermore, any one or more or all of the processing stages or units of the technology described herein may be embodied as processing stage or unit circuits/circuitry, e.g., in the form of one or more fixed-function units (hardware) (processing circuits/circuitry), and/or in the form of programmable processing circuitry that can be programmed to perform the desired operation. Equally, any one or more of the processing stages or units and processing stage or unit circuits/circuitry of the technology described herein may be provided as a separate circuit element to any one or more of the other processing stages or units or processing stage or unit circuits/circuitry, and/or any one or more or all of the processing stages or units and processing stage or unit circuits/circuitry may be at least partially formed of shared processing circuit/circuitry.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. Thus, further embodiments of the technology described herein comprise computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus further embodiments of the technology described herein comprise computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Embodiments of the technology described herein will now be described with reference to the drawings.

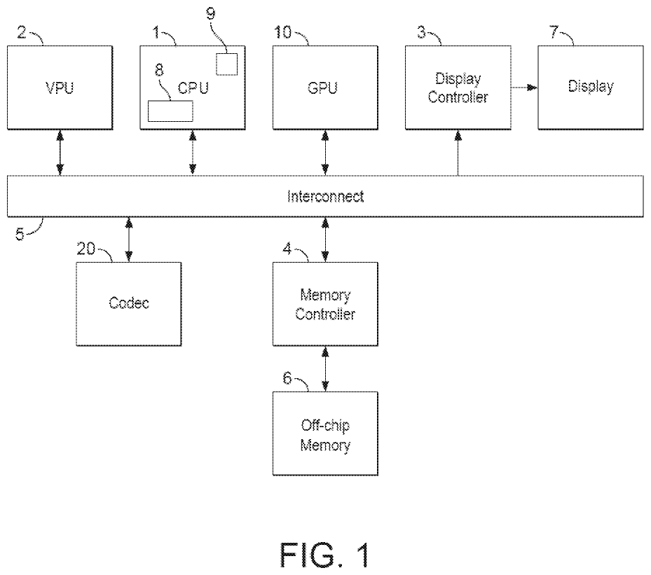

FIG. 1 shows an exemplary data processing system that comprises a host processor comprising a central processing unit (CPU) 1, a graphics processor (graphics processing unit (GPU)) 10, a video processing unit (VPU) 2, a display controller (DPU) 3, and a compression codec unit 20. As shown in FIG. 1, these data processing units can communicate via a bus 5 and have access to an off-chip memory system (memory) 6 via the bus 5 and a memory controller 4. Other processing units may be provided.

In use of this system, the CPU 1, and/or VPU 2 and/or GPU 10 may generate frames (images) to be displayed, and the display processor (DPU) 3 may provide frames to a display 7 for display. To do this the CPU 1, and/or VPU 2 and/or GPU 10 may read in data from the memory 6 via the interconnect 5, process that data, and return data to the memory 6 via the interconnect 5. The display processor (DPU) 3 may then read in that data from the memory 6 via the interconnect 5 for display on the display 7.

For example, an application 8, such as a game, executing on the host processor (CPU) 1 may require the display of graphics processing unit rendered frames on the display 7. In this case, the application 8 will send appropriate commands and data to a driver 9 for the graphics processing unit 10 that is executing on the CPU 1. The driver 9 will then generate appropriate commands and data to cause the graphics processing unit 10 to read and process data to render appropriate frames for display, and store those frames in appropriate frame buffers in main memory 6. The display processor (DPU) 3 will then read those frames into a buffer for the display 7 from where they are then read out and displayed on the display panel of the display 7.

In order to reduce the amount of data that needs to be transferred to and from memory 6 during such processing operations, the data may be stored in a compressed form in the memory 6, and the data processing system may include a compression codec unit 20 that performs the associated data compression and decompression operations.

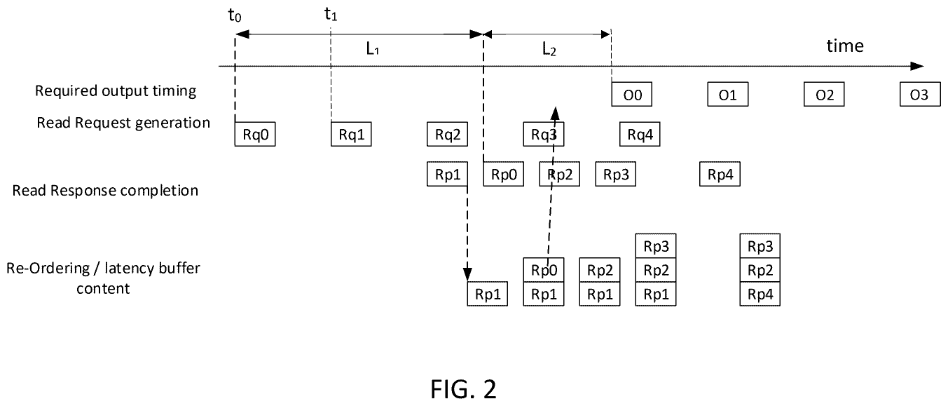

FIG. 2 illustrates operation of the display processor (DPU) 3. As illustrated by FIG. 2, the display processor (DPU) 3 may be required to provide output frames (O0, O1, O2, O3, . . . ) for display by display 7 at a frequency corresponding to the refresh rate of the display 7. To meet this requirement, the display processor (DPU) 3 may generate data requests (Rq0, Rq1, Rq2, Rq3, . . . ) taking into account a worst-case latency (L₁) associated with the memory system 6 and processing time (L₂) associated with display processor (DPU) 3 processing operations (e.g. layer merging, colour-space conversion, etc.).

Thus, for example, in order to provide output frame O0, the display processor (DPU) 3 issues request Rq0 for data Rp0 at time t₀, which is L₁+L₂ before output frame O0 is required for output. In this example, the memory system 6 returns data Rp0 in the worst-case time, L₁, the returned data Rp0 is processed by display processor (DPU) 3 for time L₂, and the output frame is provided for output at time t₀+L₁+L₂.

Similarly, in order to provide output frame O1, the display processor (DPU) 3 issues request Rq1 for data Rp1 at time t₁, which is L₁+L₂ before output frame O1 is required for output. In this example, as illustrated in FIG. 2, the memory system 6 returns data Rp1 in a shorter time than the worst-case time, L₁, and before returning data Rp0. Data Rp1 therefore needs to be buffered until display processor (DPU) 3 has received and processed data Rp0 and is ready to process data Rp1 for output. Similarly, as illustrated in FIG. 2, data for subsequent requests and output frames may need to be buffered (temporarily stored).

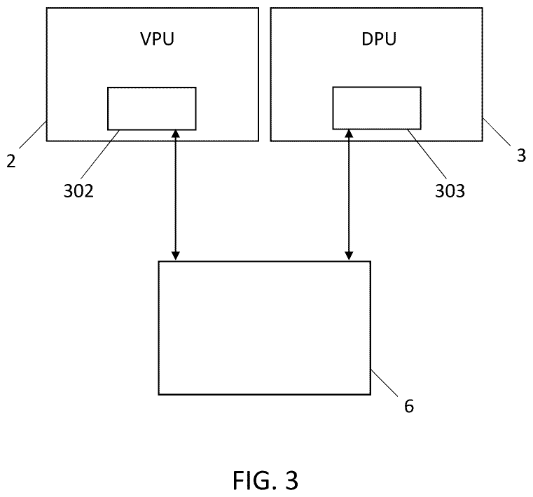

The display processor (DPU) 3 is therefore provided with a data reordering/latency buffer that is operable to buffer and re-order data returned by the memory system 6, and that has a size that is sufficiently large to account for worst-case latency, etc. For similar reasons, other processing units, e.g. CPU 1, VPU 2, GPU 10, etc., may each be provided with a respective “worst-case size” data reordering/latency buffer. This is illustrated by FIG. 3.

FIG. 3 illustrates an exemplary data processing system that comprises video processing unit (VPU) 2 and display processor (DPU) 3. FIG. 3 shows two processing units for the sake of clarity, i.e. VPU 2 and DPU 3, but it will be appreciated that the system may include other processing units, such as CPU 1, GPU 10, codec 20, etc.

As illustrated in FIG. 3, the video processing unit (VPU) 2 and display processor (DPU) 3 can communicate with the memory system 6. When DPU 3 requires data that is stored in the memory system 6, e.g. to display an image on display 7, DPU 3 issues an appropriate request for the data to the memory system 6, and the memory system 6 responds to the data request by returning the requested data to the DPU 3, e.g. as described above. Similarly, when VPU 2 requires data that is stored in the memory system 6, e.g. to encode or decode video data, VPU 2 issues a request for the data to the memory system 6, and the memory system 6 responds to the data request by returning the requested data to the VPU 2.

On account of e.g. scheduling, caching, etc., the time taken for the memory system 6 to respond and return data may vary, such that the memory system 6 may return data in a different order to an originally requested order, i.e. “out-of-order”. For example, the memory system 6 may return data for an earlier request after returning data for a later request, and/or return data for a later request before returning data for an earlier request, etc. Moreover, the memory system 6 may return different data fragments for a given request in any order.

To account for this, the DPU 3 comprises a data reordering/latency buffer 303 that buffers and re-orders data received from the memory system 6 for the DPU 3, and that has a size that is sufficiently large to account for “worst-case latency”, etc., e.g. discussed above. Similarly, the VPU 2 comprises a “worst-case size” data reordering/latency buffer 302 that buffers and re-orders data received from the memory system 6 for the VPU 2. Similarly, other processing units, such as CPU 1, GPU 10, etc., may each comprise a respective “worst-case size” data reordering/latency buffer.

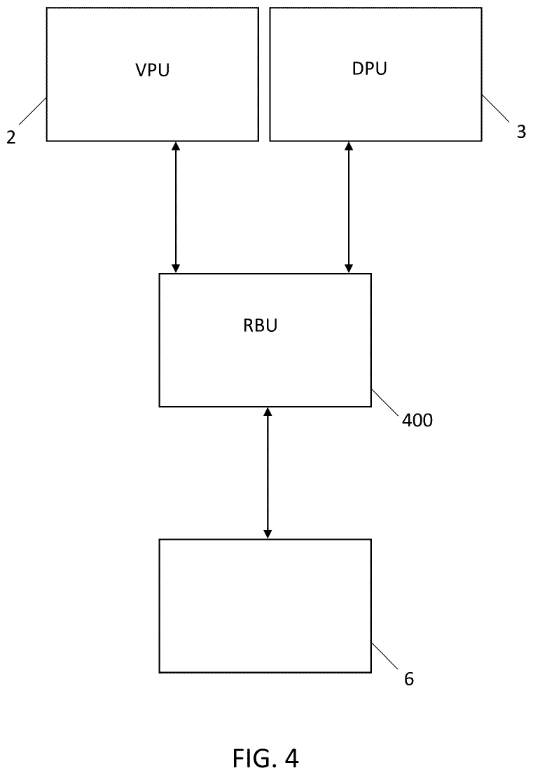

FIG. 4 illustrates a data processing system in accordance with embodiments of the technology described herein. As shown in FIG. 4, the data processing system comprises video processing unit (VPU) 2 and display processor (DPU) 3. FIG. 4 shows two processing units for the sake of clarity, i.e. VPU 2 and DPU 3, but it will be appreciated that the system may include other processing units, such as CPU 1, GPU 10, codec 20, etc.

As illustrated in FIG. 4, the data processing system of FIG. 4 is provided with a shared data reordering buffer unit (RBU) 400 that plural processing units (VPU 2, DPU 3) can communicate with. The shared data reordering buffer unit (RBU) 400 is logically between each processing unit (VPU 2, DPU 3) and the memory system 6, and is operable to buffer and re-order data received from the memory system 6 for the plural processing units (VPU 2 and DPU 3). To do this, the shared data reordering buffer unit (RBU) 400 can track an order associated with data requests issued by a (each) processing unit (VPU 2, DPU 3), receive data returned by the memory system 6 (in any order), reorder the received data based on the tracking, and return data to the requesting processing unit (VPU 2, DPU 3) e.g. in an originally requested order.

The inventors have found that providing a shared data reordering buffer 400 can reduce or remove a requirement for each data processing unit to be provided with a respective “worst-case size” private data reordering buffer (e.g. as in the arrangement of FIG. 3). Thus, providing a shared data reordering buffer 400 can reduce overall buffer requirements for data reordering operations in a data processing system, and thus reduce silicon/area requirements and improve performance and efficiency.

In the present embodiments, the shared data reordering buffer unit (RBU) 400 is a “standalone” module connected to the bus (interconnect) 5 via a bus interface. In other embodiments, the shared data reordering buffer unit 400 may be integrated in the bus (interconnect) 5.

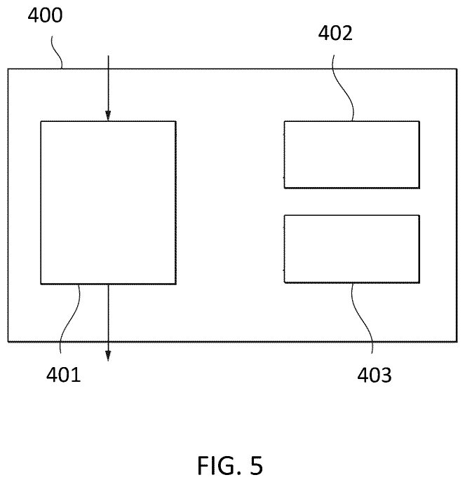

FIG. 5 shows the shared data reordering buffer unit (RBU) 400 in more detail according to embodiments. FIG. 5 shows schematically elements of the shared data reordering buffer unit (RBU) 400 that are relevant to the operation of the present embodiments. As will be appreciated by those skilled in the art, there may be other elements of the shared data reordering buffer unit (RBU) 400 that are not shown in FIG. 5.

As shown in FIG. 5, the shared data reordering buffer unit (RBU) 400 includes a bus interface module 401, a request tracking module 402, and local storage 403. The bus interface module 401 is in communication with the memory system 6 and other processing units via system bus 5, and can receive and initiate bus transactions via bus 5. The request tracking module 402 includes a set of one or more request queues that can track requests received by the bus interface module 401 from other processing units. The local storage 403 is operable to buffer data received by the bus interface module 401 from the memory system 6.

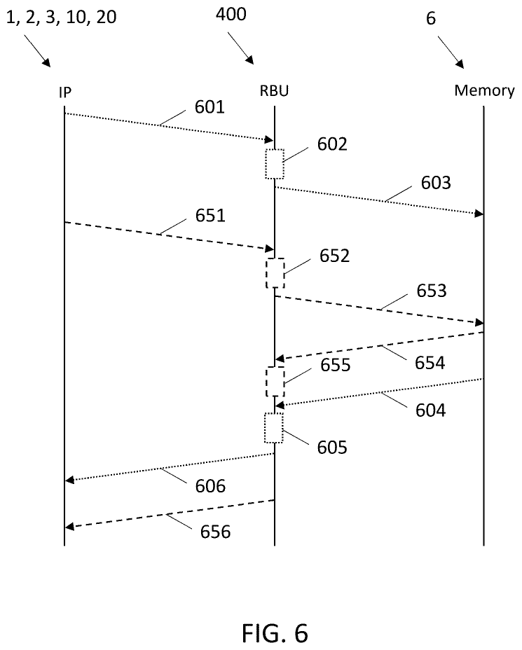

FIG. 6 illustrates operation of a data processing system in accordance with embodiments. FIG. 6 illustrates a processing unit (e.g. CPU 1, VPU 2, DPU 3, GPU 10 or codec 20) issuing a first read request 601 for first data that is stored in the memory system 6, and then issuing a second read request 651 for second data that is stored in the memory system 6.

First read request 601 may be a request from DPU 3 for image data for a first output frame, and second read request 651 may be a request from DPU 3 for image data for a second output frame, for example.

The read requests 601, 651 from the processing unit (e.g. DPU 3) may indicate that they are to be handled by the shared data reordering buffer unit (RBU) 400, e.g. by including an appropriate sideband signal, or by indicating an address that is associated with the shared data reordering buffer unit (RBU) 400.

As illustrated in FIG. 6, the first read request 601 from the processing unit (e.g. DPU 3) is received by the bus interface module 401 of the shared data reordering buffer unit (RBU) 400, and in response, the request tracking module 402 queues 602 the first read request 601 in a request queue, and the bus interface module 401 issues a corresponding read request 603 for the first data to the memory system 6. Similarly, in response to the second read request 651 from the processing unit (e.g. DPU 3) being received by the bus interface module 401 of the shared data reordering buffer unit (RBU) 400, the request tracking module 402 queues 652 the second read request 651 in the request queue, and the bus interface module 401 issues a corresponding read request 653 for the second data to the memory system 6.

In the present embodiments, the request tracking module 402 maintains plural request queues: one for each processing unit of the data processing system, and read requests 601, 651 from a (same) processing unit are queued 602, 652 in the (same) request queue for that processing unit. Other arrangements are possible. For example, request tracking module 402 may maintain a single request queue that queues requests from plural different processing units.

In the present embodiments, the shared data reordering buffer unit (RBU) 400 issues one corresponding read request 603, 653 to the memory system 6 for each incoming read request 601, 651 it receives from a processing unit. Other arrangements are possible. For example, the shared data reordering buffer unit (RBU) 400 may effectively “split” an incoming request, e.g. for a relatively large amount of data, into plural requests, e.g. for smaller amounts of data that are e.g. aligned with a transaction size of the memory system 6. Similarly, the shared data reordering buffer unit (RBU) 400 may effectively “combine” plural incoming requests into an outgoing request.

This can allow processing units to issue requests of any size (e.g. without regard to the memory system 6 configuration), with the shared data reordering buffer unit (RBU) 400 then being operable to generate and issue requests to the memory system 6 that are appropriate to the memory system 6 in question. Similarly, shared data reordering buffer unit (RBU) 400 may be (further) operable to appropriately schedule memory system requests, e.g. based on Quality of Service (QOS) requirements, etc.

As illustrated in FIG. 6, in this example, the memory system 6 responds to read requests 603, 653 from shared data reordering buffer unit (RBU) 400 out-of-order. Thus, the memory system 6 first returns 654 the second data to the shared data reordering buffer unit (RBU) 400, and then returns 604 the first data to the shared data reordering buffer unit (RBU) 400. The returned second data is received by the bus interface module 401 of the shared data reordering buffer unit (RBU) 400 and buffered (temporarily stored) 655 in the local storage 403, and the returned first data is received by the bus interface module 401 and buffered (temporarily stored) 605 in the local storage 403.

In the present embodiments, the request tracking module 402 reserves, for each request queue it is maintaining, appropriate space in the local storage 403 to buffer data returned by the memory system 6. To avoid overflow, the shared data reordering buffer unit (RBU) 400 may only issue a read request 603, 653 for data to the memory system 6 when there is sufficient space available in the local storage 403 (for the request queue in question) to store the returned data, and may otherwise stall issuing a read request. Different request queues may be allocated the same or different amounts of space in the local storage 403. For example, a request queue may be allocated more space in the local storage 403 to reduce the likelihood of stalling for that request queue. Other arrangements are possible.

In the present embodiments, the request tracking module 402 of the shared data reordering buffer unit (RBU) 400 monitors data received from the memory system 6 to determine whether all of the data for a read request that is currently at the head of a request queue has been returned. When it is determined that all of the data for a read request that is currently at the head of a request queue has been returned by the memory system 6, the read request is removed from the request queue and the data is returned to the requesting processing unit. In this way, the shared data reordering buffer unit (RBU) 400 can reorder and return data to a processing unit in an order originally requested by the processing unit.

Thus, in this example, bus interface module 401 first generates a first read response 606 to return the first data to the processing unit (e.g. DPU 3), and then generates a second read response 656 to return the second data to the processing unit (e.g. DPU 3) (even though the shared data reordering buffer unit (RBU) 400 received the second data from the memory system 6 before receiving the first data from the memory system 6).

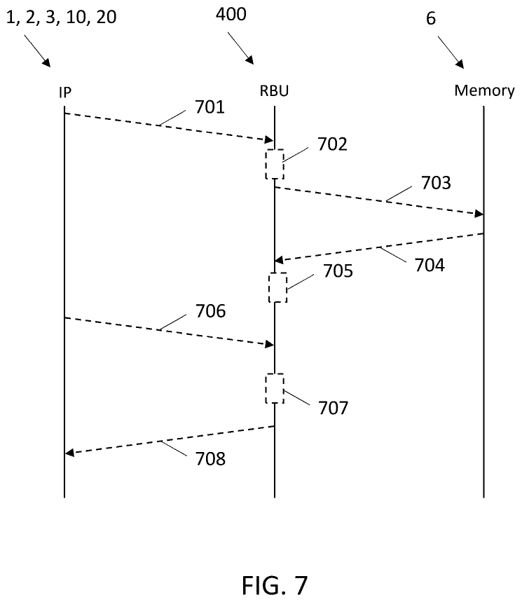

In the present embodiments, the shared data reordering buffer unit (RBU) 400 returns data to a requesting processing unit as soon as all of the data for a read request at the head of a request queue is available in the local storage 403. In other embodiments, the shared data reordering buffer unit (RBU) 400 waits for a signal from a requesting processing unit indicating that the requesting processing unit is ready to receive data before returning data to the requesting processing unit. This is illustrated by FIG. 7.

As illustrated by FIG. 7, a processing unit (e.g. CPU 1, VPU 2, DPU 3, GPU 10 or codec 20) may first issue a “pre-fetch” request 701 for data stored in the memory system 6. In response to the pre-fetch request 701, the pre-fetch request 701 is queued 702 by the request tracking module 402 in a request queue, and the bus interface module 401 issues a corresponding read request 703 for the data to the memory system 6. When the memory system 6 returns 704 the data to the shared data reordering buffer unit (RBU) 400, the returned data is buffered (temporarily stored) 705 in the local storage 403.

In the present embodiments, the request tracking module 402 maintains, for each request queued in a request queue, a “response enable flag” that controls whether or not data for the respective request can be returned to a requesting processing unit.

When a processing unit is ready to receive data, the processing unit issues a fetch request 706 that indicates to the shared data reordering buffer unit (RBU) 400 that the processing unit is ready to receive the data. In response to a fetch request 706, the request tracking module 402 determines 707 whether a corresponding pre-fetch request 701 is queued in a request queue, and if so, the response enable flag for that request is set to indicate that data for the request can now be returned to the requesting processing unit. If, in response to a fetch request, the request tracking module 402 does not find a corresponding pre-fetch request already queued in a request queue, the fetch request may be queued in a request queue with the response enable flag set, and a corresponding read request for the data may be issued to the memory system 6, etc.

The bus interface module 401 then generates a read response 708 to return data to a requesting processing unit when all of the data for a request that is currently at the head of a request queue has been returned by the memory system 6, and when the response enable flag for the request is set. This can (further) reduce buffer requirements for requesting processing units.

When a processing unit (e.g. CPU 1, VPU 2, DPU 3, or GPU 10) requires data that is stored in the memory system 6 in compressed form, the processing unit may issue a request that causes the compression codec unit 20 to fetch compressed data, decompress the compressed data, and return decompressed data to the processing unit. The compression codec unit 20 may fetch the compressed data by issuing a request that causes the shared data reordering buffer unit (RBU) 400 to fetch the compressed data from the memory system 6 and return the compressed data to the compression codec unit 20, e.g. as described above.

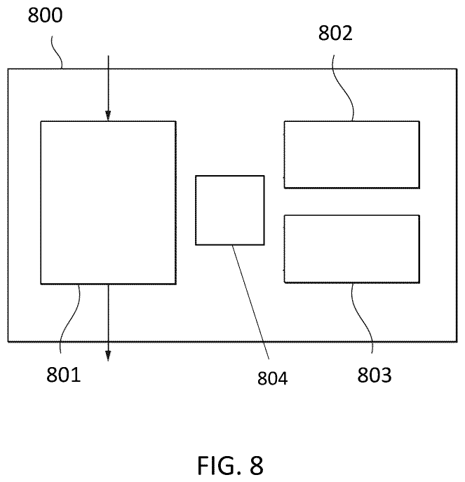

FIG. 8 illustrates an embodiment in which the function of the shared data reordering buffer unit (RBU) 400 and compression codec unit 20 are effectively combined into a single, combined data reordering and compression codec unit 800. The inventors have recognised that it is possible to combine data reordering and compression/decompression operations into a single processing unit, and that this can reduce an overall number of bus transactions associated with reading and decompressing compressed data, and (further) reduce area requirements and energy usage, for example.

As shown in FIG. 8, the combined data reordering and compression codec unit 800 includes a bus interface module 801, a request tracking module 802, and local storage 803, which may operate substantially as described above. The combined data reordering and compression codec unit 800 further comprises a compression codec 804 that is operable to compress and/or decompress data.

In this embodiment, when a processing unit (e.g. CPU 1, VPU 2, DPU 3, or GPU 10) requires data that is stored in the memory system 6 in compressed form, the processing unit issues a read request that is received by bus interface module 801 of combined data reordering and compression codec unit 800, and queued by request tracking module 802 in a request queue. Bus interface module 801 requests appropriate compressed data from the memory system 6, and compressed data returned by the memory system 6 is buffered (temporarily stored) in local storage 803.

Then, when all of the compressed data for a request at the head of a request queue has been returned by the memory system 6, compression codec 804 decompresses the compressed data, and bus interface module 801 returns the decompressed data to the processing unit.

The combined data reordering and compression codec unit 800 may decompress compressed data and return decompressed data to a requesting processing unit as soon as all of the compressed data for a request at the head of a request queue is available in the local storage 803. Alternatively, the combined data reordering and compression codec unit 800 may wait for a signal from a requesting processing unit indicating that the requesting processing unit is ready to receive decompressed data before decompressing compressed data and returning decompressed data to the requesting processing unit, e.g. substantially as described above.

Thus, when a processing unit (e.g. CPU 1, VPU 2, DPU 3, GPU 10) is not yet ready to receive decompressed data, it may issue a “pre-fetch” request that causes the combined data reordering and compression codec unit 800 to fetch compressed data from the memory system 6, and buffer the compressed data in the local storage 803. When the processing unit is ready to receive decompressed data, the processing unit may issue a fetch request that causes the combined data reordering and compression codec unit 800 to decompress compressed data and return decompressed data.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A data processing system comprising:
one or more data processing units configured to issue requests for data stored in a memory system; and
a data reordering unit configured to:
track an order of requests for data stored in the memory system issued by the one or more data processing units;
receive data requested by the one or more data processing units from the memory system; and
when the memory system returns data in a different order to an order in which data was requested:
reorder data returned by the memory system based on the tracking, and return reordered data to the one or more data processing units.

2. The data processing system of claim 1, wherein the data reordering unit is configured to:
maintain one or more request queues; and
track an order of requests for data issued by a data processing unit by queuing the requests in a request queue of the one or more request queues.

3. The data processing system of claim 1, wherein the data reordering unit is configured to:
maintain a pool of allocatable request tracking streams; and
allocate a request tracking stream of the pool of allocatable request tracking streams to track an order of requests issued by a data processing unit.

4. The data processing system of claim 1, wherein the data reordering unit comprises local storage, and is configured to store data received from the memory system in the local storage.

5. The data processing system of claim 1, wherein the data reordering unit is configured to:
determine whether data for an oldest tracked request issued by a data processing unit has been received from the memory system; and
when it is determined that data for an oldest tracked request issued by a data processing unit has been received from the memory system, return the data to the data processing unit.

6. The data processing system of claim 1, wherein the data reordering unit is configured to:
in response to a first type of request for data issued by a data processing unit, request data from the memory system; and
in response to a second type of request for data issued by a data processing unit, return data to the data processing unit.

7. The data processing system of claim 1, wherein the data reordering unit is configured to:
receive data from the memory system in encoded form;
decode data received from the memory system in encoded form; and
return decoded data to the one or more data processing units.

8. The data processing system of claim 1, wherein the one or more data processing units comprise one or more of: a central processing unit (CPU), a graphics processing unit (GPU), a video processing unit (VPU), a neutral network processing unit (NPU), a display processing unit (DPU), a compression codec unit, a sound processor, an image signal processor (ISP), and a digital signal processor (DSP).

9. A data reordering unit comprising:
one or more interfaces for communicating with one or more data processing units and a memory system; and
a processing circuit configured to:
track an order of requests for data stored in the memory system received by the one or more interfaces from the one or more data processing units;
cause the one or more interfaces to receive data requested by the one or more data processing units from the memory system; and
when the memory system returns data in a different order to an order in which data was requested:
reorder data returned by the memory system based on the tracking, and cause the one or more interfaces to return the reordered data to the one or more data processing units.

10. A method of operating a data processing system that comprises:
one or more data processing units configured to issue requests for data stored in a memory system; and
a data reordering unit;
the method comprising the data reordering unit:
tracking an order of requests for data stored in the memory system issued by the one or more data processing units;
receiving data requested by the one or more data processing units from the memory system; and
when the memory system returns data in a different order to an order in which data was requested:
reordering data returned by the memory system based on the tracking, and returning reordered data to the one or more data processing units.

11. The method of claim 10, comprising the data reordering unit: maintaining one or more request queues; and
tracking an order of requests for data issued by a data processing unit by queuing the requests in a request queue of the one or more request queues.

12. The method of claim 10, comprising the data reordering unit:
maintaining a pool of allocatable request tracking streams; and
allocating a request tracking stream of the pool of allocatable request tracking streams to track an order of requests issued by a data processing unit.

13. The method of claim 10, wherein the data reordering unit comprises local storage, and the method comprises the data reordering unit storing data received from the memory system in the local storage.

14. The method of claim 10, comprising the data reordering unit:
determining whether data for an oldest tracked request issued by a data processing unit has been received from the memory system; and
when it is determined that data for an oldest tracked request issued by a data processing unit has been received from the memory system, returning the data to the data processing unit.

15. The method of claim 10, comprising the data reordering unit:
in response to a first type of request for data issued by a data processing unit, requesting data from the memory system; and
in response to a second type of request for data issued by a data processing unit, returning data to the data processing unit.

16. The method of claim 10, comprising the data reordering unit:
receiving data from the memory system in encoded form;
decoding data received from the memory system in encoded form; and
returning decoded data to the one or more data processing units.

17. The method of claim 10, wherein the one or more data processing units comprise one or more of: a central processing unit (CPU), a graphics processing unit (GPU), a video processing unit (VPU), a neutral network processing unit (NPU), a display processing unit (DPU), a compression codec unit, a sound processor, an image signal processor (ISP), and a digital signal processor (DSP).

18. A method of operating a data reordering unit that comprises one or more interfaces for communicating with one or more data processing units and a memory system; the method comprising:
tracking an order of requests for data stored in the memory system received by the one or more interfaces from the one or more data processing units;
causing the one or more interfaces to receive data requested by the one or more data processing units from the memory system; and
when the memory system returns data in a different order to an order in which data was requested:
reordering data returned by the memory system based on the tracking, and causing the one or more interfaces to return the reordered data to the one or more data processing units.

19. A non-transitory computer readable storage medium storing software code which when executing on a processor performs the method of claim 10.
